(19) United States
(12) Patent Application Publication
(10) Pub. No.: US 2001/0035447 A1
(43) Pub. Date: Nov. 1, 2001

(54) Methods for laser cut initiation

(76) Inventors: Andreas Gartner, Melbourne, FL (US); Anthony P. Pappalardo, Palm Bay, FL (US)

Correspondence Address: Andreas Gartner, 1640 Harlock Rd., Melbourne, FL, 32934, US

(21) Appl. No.: 09/845,126

(22) Filed: Apr. 30, 2001

Related U.S. Application Data
(60) Provisional application No. 60/202,504, filed on May 5, 2000.

(51) Int. Cl. C03B 33/09

(52) U.S. Cl. 225/2; 225/93.5

(57) ABSTRACT

This invention relates to a group of methods aimed to facilitate the start of a controlled thermal scoring, shearing or separation method applied to brittle materials. More or less all thermal scoring, shearing or separation methods have in common that the specific energy level inherent to this method remains constant over the path. Such energy level sufficient to control the propagation of a crack is insufficient to start the same.

### BACKGROUND OF THE INVENTION

Prior art describes numerous methods to use a high energy source such as a beam of coherent radiation, an electron beam or a stream of super-heated media for the purpose of controlled thermal shearing of brittle materials, whereby these inventions can be distinguished from not only the form of energy application but also from their specific method to create a sufficient temperature gradient which in turn exceeds the yield strength of the material causing a crack. Most of the inventions listed in the prior art start their process from an existing edge of the material, using already present imperfections in such edge to trigger a crack which then in turn is propagated by the methods described in more detail in these inventions. Few inventions teach the purposely enforced creation of a localized fracture or crack to be used for the purpose to initiate the main fracture which then in turn is controlled in it's propagation.

Lumley (U.S. Pat. No. 3,610,871) taught a method to impinge a focused laser beam upon the lower surface of a ceramic substrate (at an extreme edge thereof) to create a precisely defined localized fracture. The substrate is then displaced to intercept the beam with the upper surface before it reaches the focal point, thus creating a widely spread energy path to controllably propagate the localized fracture along the desired direction. Verheyen (U.S. Pat. No. 3,932,726) is using a mechanical scoring tool with less than usual tool force along the desired direction and irradiates the material along such direction with a laser beam to split the already weakened material with higher speed an better edge quality than mechanical scoring by itself would be able to produce.

Lambert (U.S. Pat. No. 3,935,419) also uses mechanical scoring of the entire path to support the laser process. Morgan (U.S. Pat. No. 4,467,168) teaches a method, where a laser is focused on a glass surface to create a hole through the material and then by effecting movement between glass and laser the glass is cut. This invention is actually only quoted for reference as the material in the path of the laser is vaporized. Minakawa (U.S. Pat. No. 4,682,003) is teaching a method where the glass is molten by a laser beam, thus not requiring a cut initiation. Dekker (U.S. Pat. No. 5,084,604) uses a provided scratch or an unevenness in the side wall of the material to start the thermal load along a heating track on at least one major surface of a plate. Zonnefeld (U.S. Pat. No. 5,132,505) mentions a crack initiation without further specification which is used as a starting point for the desired line of rupture.

Kondratenko (U.S. Pat. No. 5,609,284) teaches the formation of a score or nick of gradually increasing depth to be made along the cutting line. Stevens (U.S. Pat. No. 5,622,540) uses a technique were the edge of a glass plate is manually scribed to form a crack initiation point, while the protective layer has been removed first. This resulted in a crack initiation point in form of a small score line, approximately 8 mm long and approximately 0.1 mm deep, at one edge on the top surface of the glass. Allaire (U.S. Pat. No. 5,776,220) uses virtually the same technique, a nick or score along one edge of the glass sheet, to form a crack initiation point. Ariglio (U.S. Pat. No. 5,826,772) uses an identical approach.

Matsumoto (U.S. Pat. No. 5,968,382) makes reference to a Japanese Patent No. 4-37492 where a fine hole is created by the emission of a laser beam, thus in turn generating micro cracks which are used as a starting point for the crack propagation. Matsumoto teaches a method to form a crack in preferably ceramics materials, whereby a laser beam is emitted to the starting point of the cutting (preferably from the side of the workpiece opposite to the cooled surface) and one surface is cooled. This in turn forms a crack which is then propagated.

Ostendarp (U.S. Pat. No. 5,984,159) makes reference to a German Patent No. 4 411 037 C2 in which a moving stress zone is produced in hollow glass by means of a laser beam. A short scratch is produced mechanically by a short duration contact of a scratching point or tip with the surface of the hollow glass. Ostendarp's invention itself does not teach any cut initiation, whereby it can be assumed to require such.

### SUMMARY OF THE INVENTION

This invention relates to a group of methods aimed to facilitate the start of a controlled thermal scoring, shearing or separation operation applied to brittle materials whereby the thermal shearing methods themselves are not covered in this invention or only insofar as to describe the specific initiation method which has to be found useful for a certain thermal technique. What more or less all thermal scoring, shearing or separation methods have in common is that the propagation of a crack requires a constant energy level, commonly supplied by a laser source or any other energy source. Such energy level sufficient to control the propagation of a crack is insufficient to start the same process. It would be ideal to initiate such propagation with the same energy source on hand for the further propagation, but unfortunately a typical laser source can not switch from high energy output to low but very stable output in the required time to pick up the initiation. At first it is not obvious why a time factor between initiation and propagation is involved, as in a scenario as described in prior art, where a scratch or nick is applied to one edge and then in turn being pick up by the propagation mechanism, timing should be completely unimportant. Typical industrial applications though require more sophisticated initiation methods, for example when a thermal method is used to separate strips from a sheet of brittle material, which then in turn need to as well be cut in perpendicular direction to yield square or rectangular shaped bodies. Here a “in-process” initiation is necessary and timing between initiation process and propagation mechanism becomes an issue. Another examples which will also be described later in more detail is the absence of an edge to start the thermal shearing process from. So when a thermal scoring, shearing or separation process needs to start for example in the center of a workpiece the benefit of a small scratch at the edge is not available. Yet another example is when a thermal scoring, shearing or separation process is not allowed to leave even the tiniest initiation mark on the substrate, as required by several applications. In this case a completely new group of methods needs to be employed, which will also be described later on in more detail.

The initiation methods described by this invention will be grouped in mechanical indentation methods with distinct initiation spot, timed mechanical methods without distinct initiation spot, methods which explore controlled subsurface damage, mechanical methods using an offset, quasi-continuous mechanical methods, ultrasonic methods with and without distinct initiation spot, pulsed laser methods as well as continuous laser methods.

### DESCRIPTION OF DRAWINGS

FIG. 1 shows the energy level necessary to start a thermal score, shearing or separation system in relation to the energy level needed to protrude a once formed crack throughout the material.

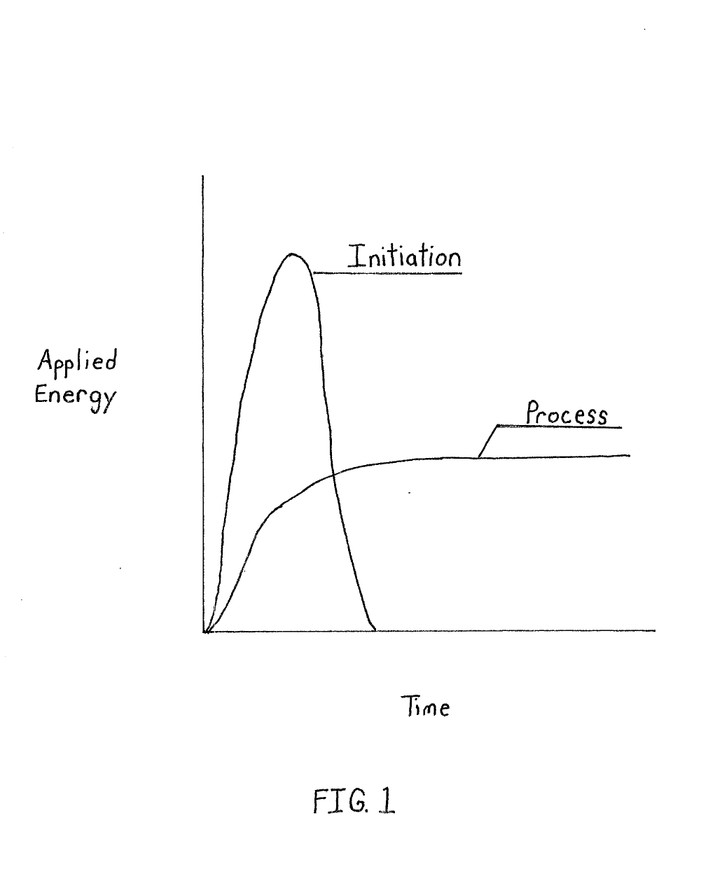

FIG. 2 shows an example of a device for the first group of methods, a mechanical indentation tool featuring a hard metal wheel in a holder which is being brought in contact with one edge of the substrate

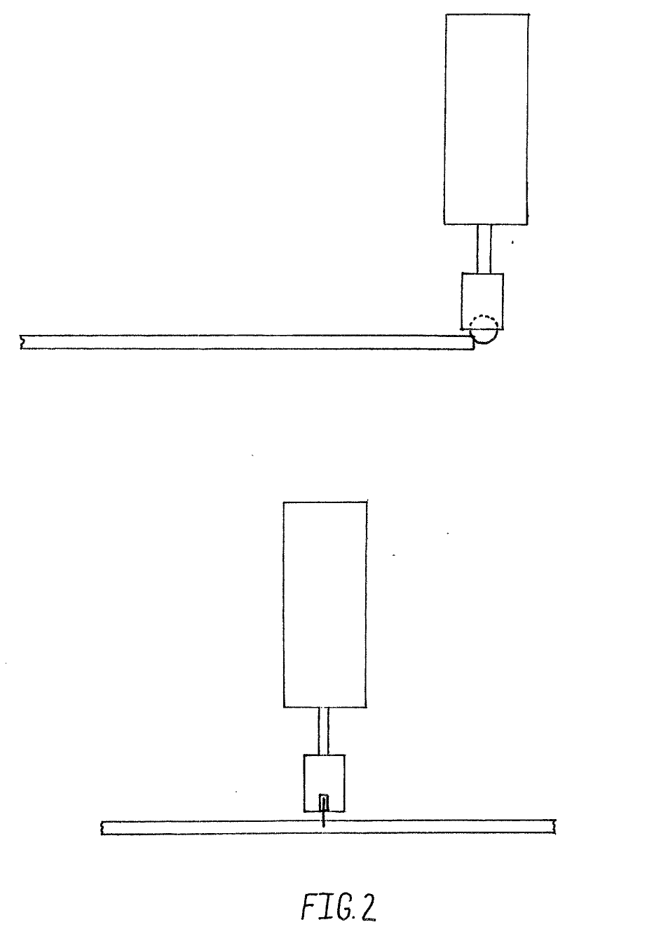

FIG. 3 shows another example of the same group, a tip mounted on an air cylinder, which actuates the interchangeable insert towards the substrate surface, as well as multiple examples of tips.

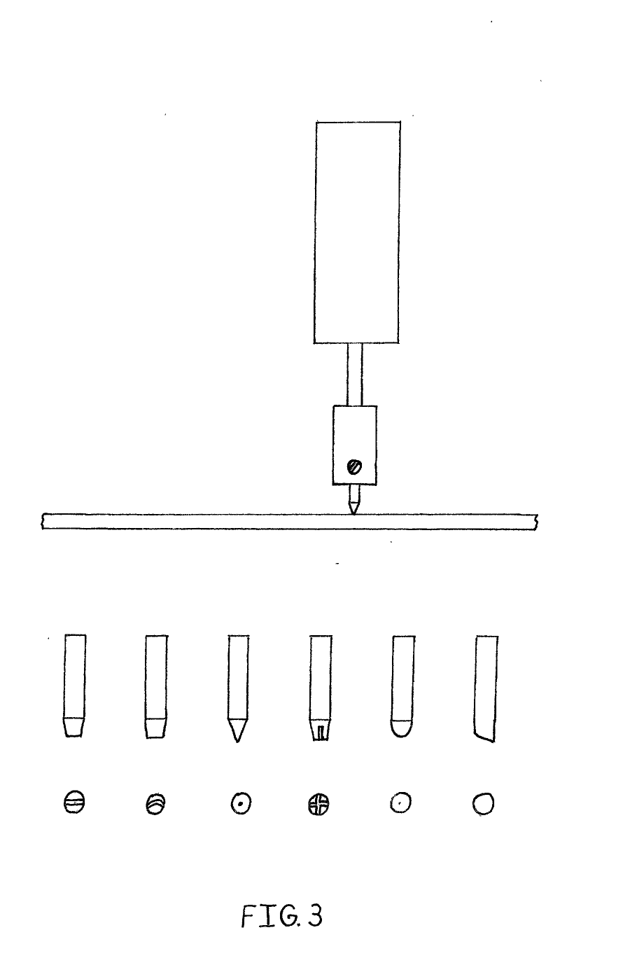

FIG. 4 shows an example of an assembly used for the timed mechanical methods where a blunt tip is pressed towards the surface of the glass and just retracted when the energy release from the thermal system coincides with the very spot. Also different tip geometries are shown, symmetrical as well as asymmetrical.

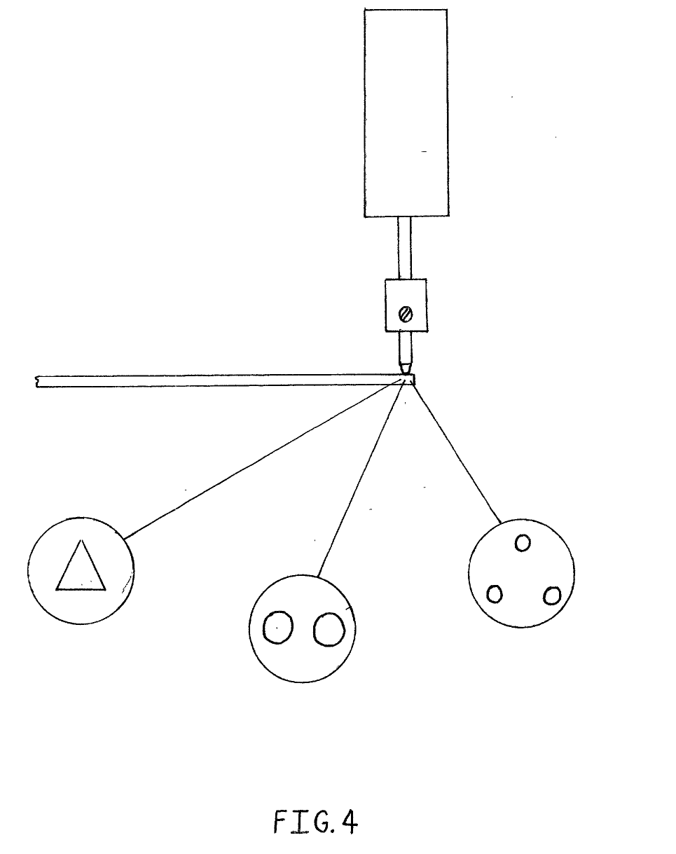

FIG. 5 symbolizes the subsurface damage of a typical brittle material which is sufficient to create a initiation point for a heat related method.

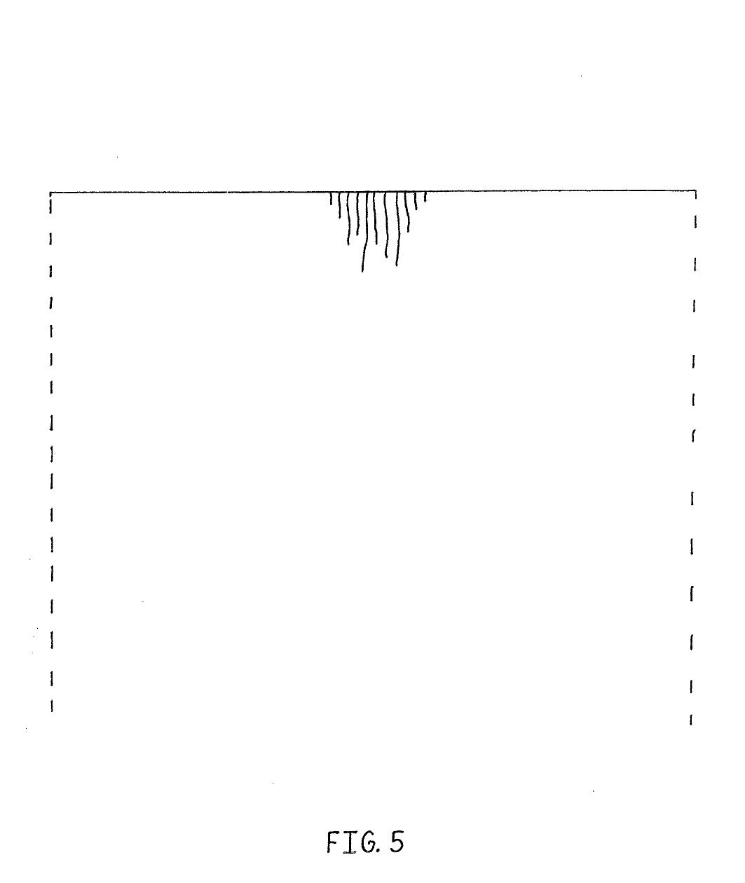

FIG. 6 shows an offset initiation in a typical application, whereby the initiation used for this embodiment can be either of the described methods.

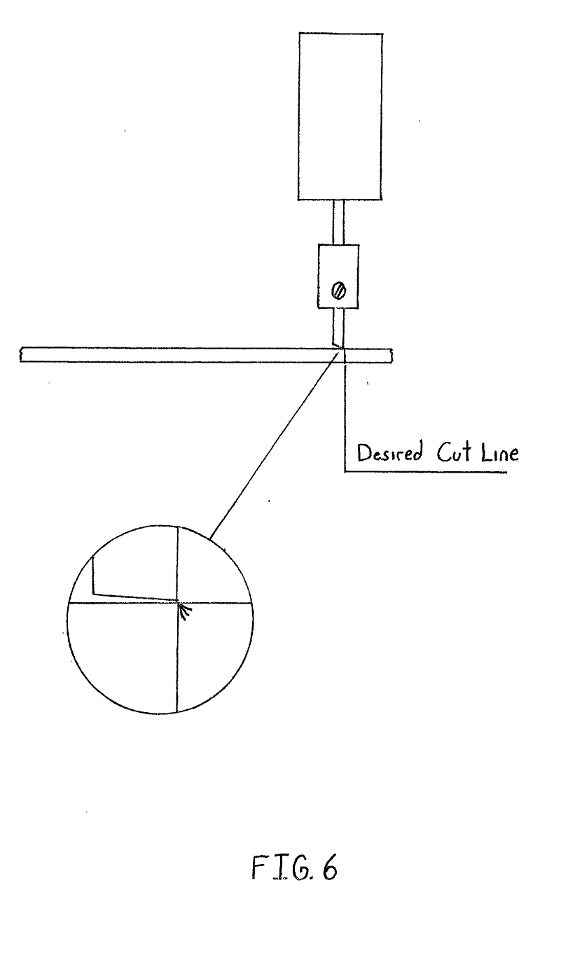

FIG. 7 shows a side view of a typical ultrasonic initiation with either air or water or in yet another embodiment a fine water mist in air or nitrogen as transfer media. Several horn configurations are shown, whereby special emphasis is put on the concave horn which actually focuses the ultrasonic energy towards the intended initiation point. By purposely moving the substrate surface or edge in or out of focus the effect can be precisely controlled.

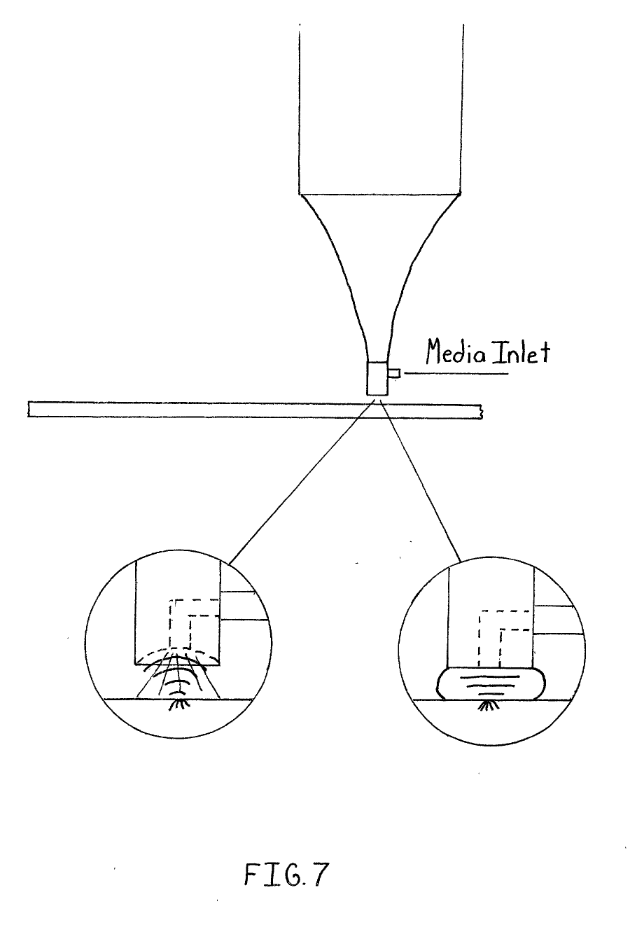

FIG. 8 shows the formation of a quasi-monolithic body from several individual pieces by applying force perpendicular to the separation direction, which presents the so formed monolithic body towards the thermal process as a homogenuous piece, without requiring re-initiation along the path of a desired scoring or singulation (“cross-cutting”).

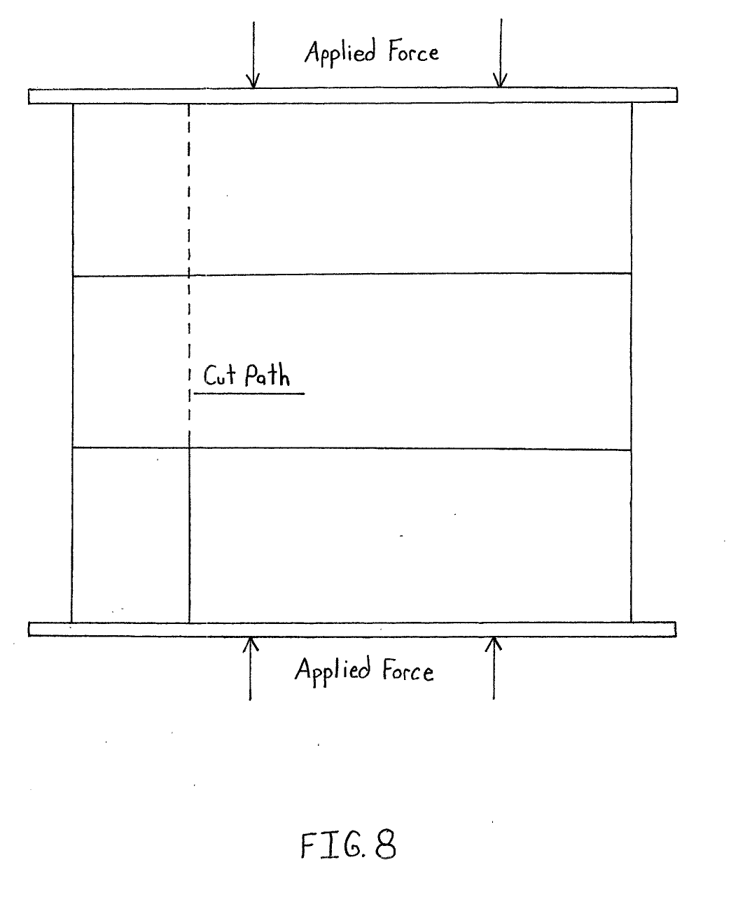

FIG. 9 shows a typical embodiment for a pulsed or quasi-continuous laser initiation, whereby the device can be used in conjunction with the actual propagation mechanism to re-initiate in cross-cut situations.

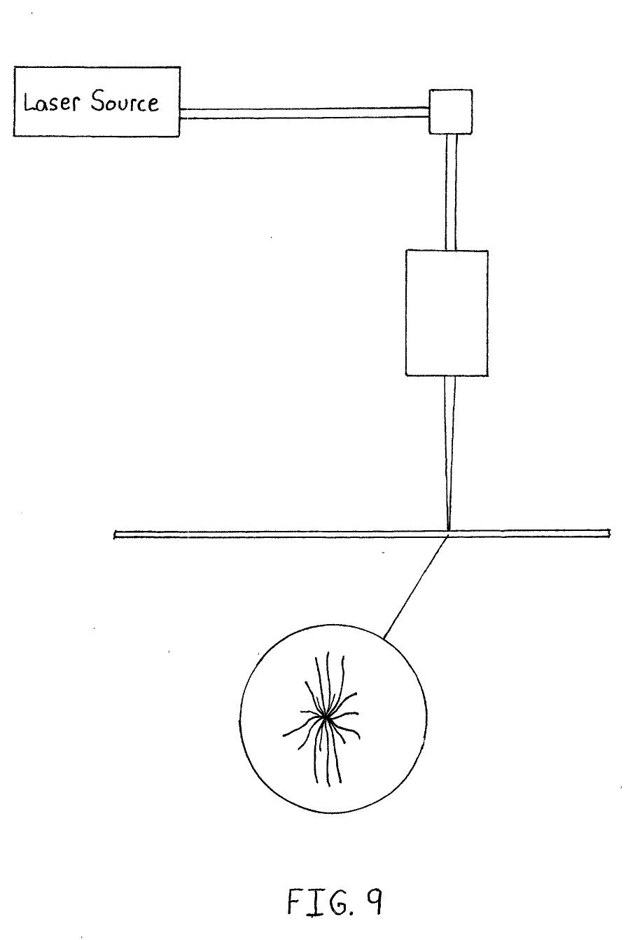

### DETAILED DESCRIPTION OF THE INVENTION

The first group of methods according to this invention is dealing with mechanical indentation with distinct indentation spot. A stylus made of a material harder than the substrate is pressed without relative movement in x or y direction on the surface or an adjacent side of the substrate to create a tiny indentation mark. From our experiments the mark can be as small as a few microns only to be reliably picked up by the thermal system. Typical materials can be Sapphire, hardened metal, diamond impregnated metal or diamond, whereby any material with a higher degree of hardness than the substrate will suffice. In a preferred embodiment a stylus with interchangeable tips is accelerated by an air cylinder or any other mechanical means towards the substrate. The tip can be shaped like a cone, whereby the shoulder angle of the frustum was found to be preferred in a range between 50 and 80 degrees. Obtuse angles produce a more shallow indentation and are easier to control than acute angles which show a higher degree of penetration, but tend to uncontrollable microfracture. The force with which such tip is accelerated perpendicular towards the material surface or side is preferred between 0.5 and 20 N, but certainly not limited to this range as the force is a function of the integrity of the material to be indented. On round surfaces it was shown to be beneficial to put the tip on a path tangential to the main surface of the round workpiece. In order to reduce the amount of debris created by such indentation a modified approach can be used, to increase the force but reduce the relative speed of the tip towards the surface. This results in a compression of the top surface on the impact point of the tip, which is sufficient to reliably start a thermal process but create almost no debris. In general, the impact crater left behind by the tip is a function of the specific hardness of the materials used, as well as the acceleration and force of the tip. In a preferred embodiment an air or hydraulic cylinder is used to accelerate the tip, whereby the force can be controlled with the pressure of the media. The penetration depth is mainly a function of the shoulder angle of a conical tip or in general the geometry of such tip and the impact area. It has been shown that by using an additional valve on a bidirectional cylinder which is put to the side opposing the working direction an air cushion can be created to allow repeatable deceleration in the last few millimeters travel to effectively dampen the impact. The fracture can be controlled to be only a few square Microns whereby on a typical conical tip the ratio between penetration depth and impact diameter is between 0.5 and 2. It is beneficial to control the impact in a way that no fractures or cracks are created outside the impact crater area. In such case the thermal method comes to use just the center spot of the indentation to protrude a crack. Therefore the starting position of the thermal system is highly defined. The described group of methods is independent from timing issues. It does not matter whether the thermal system is activated within a few Seconds after impact or even several months. It was also noted that no degrading of the ability to reliably start a thermal crack protrusion occurred over an extended period of time.

Insofar we only described a method assuming that the tip geometry is symmetrical. Extended experiments were conducted with asymmetrical tips as well. A preferred embodiment is a cylindrical tip cut in an obtuse angle or a paraboloid with offset center. The elevation of one side over the other is within only tenths of a millimeter. If a such shaped tip is forced perpendicular on the substrate the higher side will impact first and tends to compress the material similarly in all directions but only until the lower side of the asymmetric body comes in contact. This is when the material is compressed more to one side than to the other, creating compression and counteracting tension forces. Such geometry can be used to offset the true impact of the indentation from the starting position of the heat system. It was shown in experiments that the heat system picks up a position between 1 and 10 radii from the center of the impact crater. This technique can be used where the material is not supposed to show any signs of an initiation. Instead of having half of the initiation crater on each side of the separation as with the symmetrical tip methods, this technique can be used to put the entire initiation crater to one side of the separation, in turn yielding one side without any initiation marks.

The second group according to this invention are timed mechanical methods without distinct indentation mark. The embodiment is very closely related to the first group but the major distinction is the hardness of the tips. This group of methods is using a tip material softer or of similar hardness than the substrate. The elastic limit of the material is not exceeded, so no permanent crater is formed. Experiments showed that Marble, Barite, Dolomite and Fluorite are preferred materials, but certainly this group of methods is not limited to the use of these materials. A tip preferably of triangular shape is used in the same setup as previous, an air or hydraulic cylinder. The sides of the regular triangle measure between 100 and 500 micron. The triangle is oriented in a way that the corner formed by two coinciding sides points to the desired starting point of the thermal system, preferably in a distance of not more than 0.5 to 1 millimeter. The tip is pressed firmly (with a force between, but not limited to 0.5 and 1 N) to the surface of the substrate and the thermal system is aligned to split the triangle in two similar halves. The thermal system starts the heat flux, picks up the stress created by the tip and the tip retracts to not block the path of the thermal system protruding the crack. Obviously the timing is very critical for the success of this method. Improvements were made to this general method by using dual and even triple tips in a geometry to guide the created stress field to a defined starting point for the thermal system. It was shown that two round tips mounted in a distance of approximately 1000 Microns from each other with a diameter of approximately 500 Micron, pressed towards the surface of the substrate in a distance of not more than 250 microns from the edge provide a reliable starting point for a thermal method. Yet another embodiment, three tips of approximately 250 micron diameter mounted in the corner points of a regular triangle of a sidelength of approximately 2000 micron could reliably get a thermal system started inside a material, far away from any edge. Using this method, a circular cut could be started in the middle of a for example square piece of material.

Yet another group of methods in this invention covers subsurface damage methods. These methods create a multitude of ultrafine scratches in the top surface of the material (“subsurface”), which can hardly been seen without optical means. The preferred embodiment can be as simple as an abrasive cloth or a resin bond diamond tool as used on lapping machines. It is important to orient the scratch pattern in parallel to the desired direction of the thermal system. This method has initially been designed for the cut initiation on tubes or in general hollow cylindrical bodies. Usually the crack formation of the thermal system follows the strongest disturbance of the material structure or lattice. In this case, as all these ultra-fine scratches are very similar, this group of methods benefits from the specific, very distinct, high energy areas as used in the thermal methods for the singulation of tubes. The “hot core” or area with maximum energy in the beam projection finds a suitable ultra-fine scratch directly in the path and protrudes a crack from there. The multitude of scratches is hereby not detrimental to the accuracy as due to the ultra-fine nature of these scratches only the one will be picked up which is directly located in very close proximity to the high energy center of the beam projection. The depth of scratches could not directly been measured and was therefore determined using the average roughness (R sub a) of the surface. (R sub a) values of between 0.05 to 0.1 micron were shown to reliably get a thermal system started. According to the literature does a (R sub a) of such value range correspond to a subsurface damage of approximately 20 microns depth, so the effects of a for example 0.1 Micron scratch on the surface can still be found 20 micron below the surface, nonetheless that the scratch itself is restricted to the surface. In a preferred embodiment a round or rectangular shaped resin bond Diamond or Titanium carbide tool with an abrasive granulation of not more than 1 micron was pressed with a force of between 1 and 10 N to the surface of the substrate and moved relative to either the x or y axis, but in any case parallel to the desired cut direction, for a few millimeters travel and then lifted off the substrate surface.

Virtually no debris is created by this method and the impact point of the lapping tool is hardly made out without using optical instruments. In case of a tube, which is set in rotation for the thermal system to be delivered in a stationary mode, within 1 revolution the point where the thermal system impinges the surface of the tube will meet the area with subsurface damage and pick up a crack from the center of the high energy area in the beam projection. Yet another application was trying to apply this method to flat substrates, by repeating said method on a flat piece of material. As long as the scratch area was not to far away from a side of the substrate (which has been cut by laser to avoid any misleading microcracks from the chosen separation method), the reliability of getting a thermal system started was above 80 percent. It was though noted, that the required force was considerably higher (5 to 20 N) than required for round bodies.

Another group of methods in this invention explored the concept of offset initiation as already described in the asymmetrical tip or craterless timed methods even further. The offset initiation methods found use in mainly closed contour thermal separation paths. In a preferred embodiment a annular shape is desired, with a distinct outside diameter as well as a distinct inside diameter. The material between outside and inside diameter is used in this application and is not supposed to show any signs of cut initiation, neither form the inside not from the outside cut. As yet another requirement of this application is high dimensional accuracy of the part as well as repeatability, neither the asymmetrical tip nor the impactless dual- or triple tip method could be used. The reason was not so much a lack of accuracy in these methods, but residual stress inside the material from a previous operation, which would have caused these methods to shift their maxima as a reaction to encountering a sizable residual stress field in the material. As the interaction level of these methods is weak, especially in the dual- or triple tip timed method, the method accuracy suffers if a counteracting force such as residual stress is met. Therefore we used a strong interaction method such as the symmetrical tip method offset from the path. The symmetrical tip method is reliably picked up by thermal separation methods, even if a strong residual stress field is met as the extent of energy causing the material damage in this method is several orders of magnitude higher than the typical residual stress. The impact crater was positioned inside the desired inner diameter and outside the desired outside diameter. The path of the thermal system was set to coincide with this offset initiation mark, which can be up to several Millimeters away from the desired diameter, pick up the distinct initiation mark and approach the main diameter within one or several revolutions. The speed of the motion system was set to the maximum of the accessible process window in order to create only a shallow scribe- or scoreline. Once the main diameter was met, the motion system slowed down to increase the depth of the scribe- or scoreline on the main diameter, in effect creating a scribe- or scoreline completely without initiation marks. The same method obviously also works on different shapes as well.

Yet another group of methods in this invention are quasi-continuous mechanical methods. A preferred embodiment is again the cross cut of already perpendicular or at any angle thermally or mechanically separated pieces. If a thermal separation is desired perpendicular or at any angle to the previous separation direction, a continuous re-initiation of edges formed by previous separations is required. A typical application, the production of microscope slides, is carried out by first performing all cuts in one direction, rotating the process table holding the individual strips, and performing multiple perpendicular cuts according to the desired width or length of the product. In this case, every width or length of the product a new initiation is required. The most simple approach is to drag a initiator with a very fine tip permanently ahead of the thermal system in order to create a very fine continuous score line. The definite drawback of this approach is the amount of debris created, the wear of the tip as well as a permanent mechanical scoreline. The preferred embodiment is a motion system with continuous position feedback to the controller which in turn triggers a device as described in one of the previous mechanical methods, mounted ahead of the direction of movement of the thermal system, which creates an initiation mark on or close to the edge of the next strip, which in turn is picked up by the approaching thermal system. Certainly the same effect will be possible with the ultrasonic or laser methods described hereafter.

A different embodiment is much simpler and actually does not require any initiation. If the same strips as we had before, separated along one axis and desired to be cut along another axis or in any angle to the first axis are pressed together with a force linear to the number of separations, a quasi-continuous body is formed which behaves towards a thermal system as a monolithic body and can therefore be separated without re-initiating the individual strips. The force is applied against the last strip, whereby the first strip comes to a rest against a shoulder in the process table. With or without vacuum support on the process table, the last strip is pushed towards the first strip by means of multiple retractable elements. Such the edge of the last strip is not in jeopardy of becoming damaged.

Yet another group of methods according to this invention are ultrasonic techniques. Experiments were conducted with different horn assemblies as well as with different types of generators. It turned out that two horn styles were particularly well suited for this application. The first horn design is a flat round spot on a exponential tapered horn, whereby the displacement magnification is a ratio of the diameter of the horn base to the horn tip. The substrate was submerged in a thin layer of water or any other liquid with a sufficient sound speed coefficient to form a layer on the top side of the substrate not thicker than 10 Millimeter. The tip of the beforementioned horn assembly was brought in contact with the liquid surface and submerged further to stand approximately 5 Millimeter above the surface of the substrate. A fixed frequency generator was used with alternatively 20,000 Hz, 30,000 Hz or 40,000 Hz. The frequency was chosen to correspond closest (for this specific setup) to the resonance frequency of the substrate in the liquid bath, what was ascertained by measuring the return amperage of the horn and finding the minimum for a certain geometry. The mass of the substrate as well as the mass of the water or fluid in the container was chosen to match the frequency response of the ultrasonic horn. For a certain minimum the distance between tip of the horn and substrate surface was reduced (from a 5 Millimeter starting point) to find the nodal point. On the nodal point a sharp crack was formed in the material surface or material edge which though could not be controlled very well. The extent of lattice damage was more than sufficient to get a thermal process started, but overall the process lacked practical usability. The method could be improved by using a stepped horn, which does give more leeway in terms of displacement magnification as the magnification is the square of the diameter ratio. This allowed us to not have to submerge the entire substrate in water or fluid but to use a nozzle to spray a drop of water just in the gap between horn tip and substrate surface. The higher magnification compensated effectively for the loss in the heterogenous transfer media (air cushion plus water). This method yielded highly repeatable initiation marks, which were still rather big. In order to reduce the size or concentrate the impact a different horn construction was used. A concave horn with an opening of 5 Millimeter was placed in a way to coincide the focal plane with the substrate surface. A water mist was sprayed towards the focal point to overcome the poor speed of sound in normal air. This preferred embodiment yielded distinctly located fractures even on arbitrary spots of the substrate surface not coinciding with an edge.

Another group of methods according to this invention used pulsed laser sources of a wavelength between 1 and 11 microns. Using a focusing lens in the beam path of the laser source a focal plane was created on the top surface of the material. A short duration pulse (in the preferred embodiment not more than 50 Microseconds) was directed towards the material and repeated with a duty ratio of preferably not more than 35 percent. The resulting pulse period was approximately 140 microseconds. The average power of the pulse for the laser sources used was approximately 150 W. These values are more governed by the available equipment than the method. Experiments showed that as long as an average pulse power of at least 125 W, focused to a spot of not more than 0.5 square millimeter, could be maintained, favorable results could be achieved on most brittle materials. Certainly, a person skilled in the art could use different lenses or laser source combinations to achieve the same results with different parameters. In a preferred embodiment the focal plane is put slightly underneath the true material surface, whereby 10 to 50 microns were found to produce the best results. The shutter in the beam path was controlled by a computer to allow precisely measured shutter open times. The overall shutter open time governs the heat flux in the substrate as the point of the impingement is allowed no relative movement during this process. Materials with high thermal conductivity require more heat flux; this is required as well for materials with high Young's Modulus values. The process time (shutter open time) was found experimentally for a wide variety of frangible materials. Also, highly pulsed laser sources were used which can be considered quasi-continuous. For pulse widths of about 50 microseconds duration the actual laser output is more triangular than square in shape. The advantage of this characteristics is at short pulse periods, the peak processing power decreases due to the rise and fall time. As the pulse period is reduced for this triangular shaped peaks, the base of the triangles merge into each other, thus creating a quasi-continuous effect. The process time (shutter open time) for the same material is shorter for quasi-continuous laser sources. Other than the difference in process time is the method identical for pulsed as well as quasi-continuous laser sources. When the laser pulse or quasi-continuous radiation impinges on a spot on or slightly underneath the surface of the material structural damage is done to the material, which can be controlled from tiny fractures in a star shaped pattern with the impingement point as center to sizeable cracks.

We claim:

1. A mechanical indentation method to create a distinct indentation spot capable of starting a thermal score- or separation system, whereby
a. A symmetrical shaped tip made from a material of equal or higher degree of hardness than the substrate is forced towards the material with a certain acceleration and force
b. The tip impinges on an arbitrary spot of the substrate
c. On tubular bodies the tip impinges on a tangent to the surface of the body.
d. The impinged point lies on the path of the thermal score or separation.

2. The method from claim 1./ whereby a fracture area of only a few square microns is generated

3. The method from claim 1./ whereby the shape of the tip governs the impact area and depth

4. A mechanical indentation method to create a distinct spot capable of starting a thermal score- or separation system whereby one or a multitude of asymmetrical shaped tips are used to create an asymmetrical stress pattern in the material so that the thermal score- or separation system can be started without that the path of such system would coincide with the impact spot.

5. A mechanical method to create a temporary stress area on an arbitrary point of the substrate without distinct indentation mark, whereby
a. The symmetrical or asymmetrical tip made from a material softer or almost equal in hardness than the substrate is pushed towards the material with a certain force
b. The thermal scoring or separation system picks up the stress created by such tip and the tip retracts to not block the path of the thermal system

6. A mechanical method to create ultrafine scratches on the surface of the substrate parallel to the desired direction of the thermal score- or separation system, along with a certain subsurface damage, whereby
a. a resin bond abrasive tool is displaced on the substrate surface relative to the starting point, but parallel to the desired direction of the score- or separation method
b. Any other material capable of creating ultrafine scratches in the relevant substance can be used as well.

7. A method to create a suitable starting point for a thermal scoring or separation method offset from the path of the thermal system by using one of the methods from claim 1./, claim 5./ or claim 6./ and approach the intended path gradually, whereby the scoring depth of the approach path is less than the scoring depth of the main path.

8. A method to push already separated pieces together, perpendicular to the separation direction to form a quasi-monolithic body kept under temporary stress. The force applied is hereby linear to the number of separations. For such a quasi-monolithic body no re-initiation on the individual edges of the pieces is necessary to maintain a thermal score- or separation system.

9. A method to create a suitable starting point for a thermal scoring or separation system by using ultrasonic energy directed towards the substrate surface,
a. A exponentially tapered horn is used. Substrate and horn are submerged in the same liquid bath and the amperage drawn by the transceiver mounted atop the horn is closely controlled to find a minima, at which point the closest match to the resonance frequency of the substrate is given.
b. A stepped horn is used in conjunction with a nozzle to provide a liquid layer to the gap formed between horn tip and substrate surface and the amperage drawn by the transceiver mounted atop the horn is closely controlled to find a minima, at which point the closest match to the resonance frequency of the substrate is given.
c. A concave horn with a distinct focal point outside the horn assembly is used in conjunction with a nozzle to spray a water mist towards the focal point of the ultrasonic energy and the amperage drawn by the transceiver mounted atop the horn is closely controlled to find a minima, at which point the closest match to the resonance frequency of the substrate is met.

10. A method to create a suitable starting point for a thermal scoring or separation system by means of a pulsed laser source, focused on or slightly underneath the surface of the substrate, whereby the shutter open time and pulse width controls the extent of damage to the lattice of the substrate.

11. A method to create a suitable starting point for a thermal scoring or separation system by means of a quasi-continuous laser source, focused on or slightly underneath the surface of the substrate, whereby the shutter open time and laser power controls the extent of damage to the lattice of the substrate.
